(19) United States
(12) Patent Application Publication
(10) Pub. No.: US 2025/0318628 A1
(43) Pub. Date: Oct. 16, 2025

(54) Skin Care Lotion or Gel Applicator

(71) Applicant: Kevin Erlewein, Madison, IN (US)

(72) Inventor: Kevin Erlewein, Madison, IN (US)

(21) Appl. No.: 18/632,039

(22) Filed: Apr. 10, 2024

(51) Int. Cl. A45D 40/26; A61H 7/00

(52) U.S. Cl. CPC A45D 40/26; A61H 7/003; A45D 2200/054; A45D 2200/1018; A61H 2201/105; A61H 2201/1695; A61H 2205/081

(57) ABSTRACT

A skin care treatment material applicator includes a housing, a compartment, and a dispensing assembly. The housing has an outer surface and includes an elongated handle portion and a head portion to apply skin care treatment material to a user. The compartment is positioned in the housing and contains a supply of flowable skin care treatment material. The dispensing assembly is positioned in the housing and includes a pump connected to the compartment and an outlet positioned in the head portion to dispense skin care treatment material to an outer surface of the head portion. The skin care treatment material applicator is used to apply skin care treatment material, such as lotions, gels, creams, or foams, to parts of a user's skin that are difficult to reach, such as on the back.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to skin care devices and more particularly pertains to a new skin care treatment material applicator for applying skin care treatment material, such as suntan lotion, skin cream, aloe vera gel, or any other flowable material for treating various skin conditions, such as burns, rashes, and dry skin.

### (2) Description of Related Art Including Information Disclosed Under 37 CFR 1.97 and 1.98

The prior art relates to skin care devices. The prior art, as best understood, does not disclose skin care treatment material applicator generally comprising a housing, a compartment, and a dispensing assembly that includes a pump connected to the compartment and an outlet positioned in a head portion of the housing to dispense skin care treatment material to an outer surface of the head portion, which head portion comprises an applicator pad designed to rub the skin care treatment material into the skin of a user.

### BRIEF SUMMARY OF THE INVENTION

An embodiment of the disclosure meets the needs presented above in a skin care treatment material applicator generally comprising a housing, a compartment, and a dispensing assembly. The housing has an outer surface and includes an elongated handle portion and a head portion to apply skin care treatment material to a user. The compartment is positioned in the housing and contains a supply of flowable skin care treatment material. The dispensing assembly is positioned in the housing and includes a pump connected to the compartment and an outlet positioned in the head portion to dispense skin care treatment material to an outer surface of the head portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a skin care treatment material applicator according to an embodiment of the disclosure.

FIG. 2 is an end view of an embodiment of the disclosure.

FIG. 3 is a top view of an embodiment of the disclosure.

FIG. 4 is a cross-sectional view of an embodiment of the disclosure.

FIG. 5 is a perspective view of an embodiment of the disclosure in use.

### DETAILED DESCRIPTION OF THE INVENTION

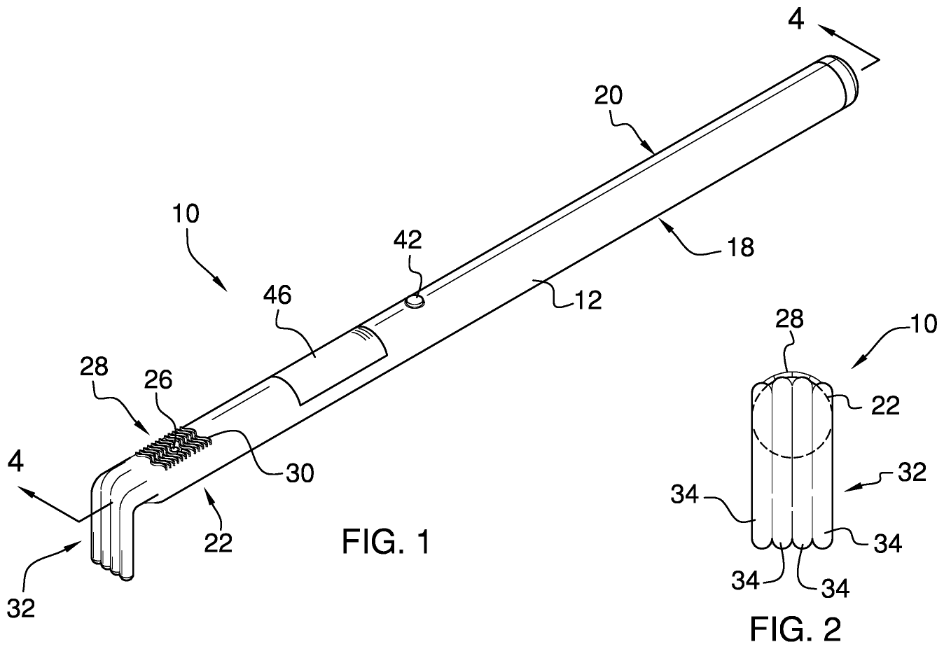

With reference now to the drawings, and in particular to FIGS. 1 through 5 thereof, a new skin care treatment material applicator embodying the principles and concepts of an embodiment of the disclosure and generally designated by the reference numeral 10 will be described.

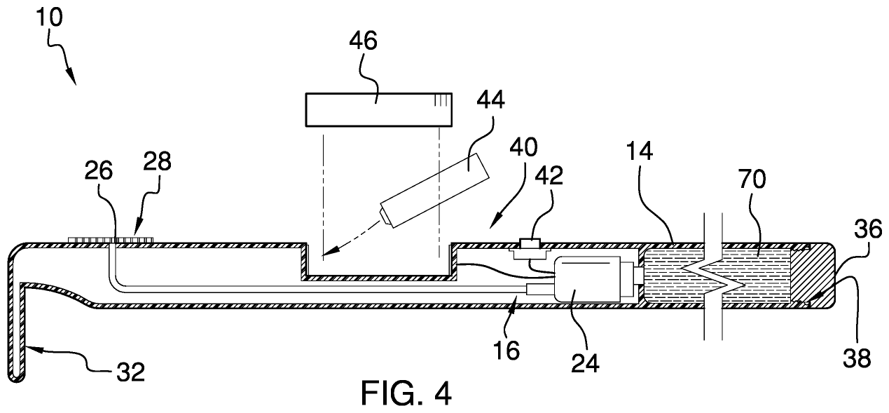

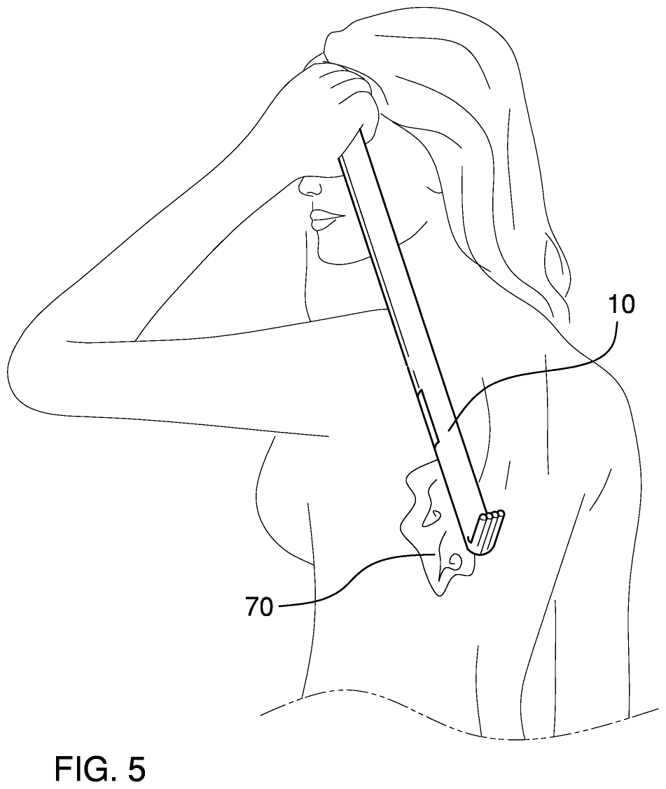

As best illustrated in FIGS. 1 through 5, the skin care treatment material applicator 10 generally comprises a housing 12, a compartment 14, and a dispensing assembly 16. The housing 12 has an outer surface 18 and includes an elongated handle portion 20 and a head portion 22 to apply skin care treatment material 70 to a user. As best seen in FIG. 4, the compartment 14 is positioned in the housing 12 and contains a supply of flowable skin care treatment material 70. Also as seen in FIG. 4, the dispensing assembly 16 is positioned in the housing 12 and includes a pump 24 connected to the compartment 14 and an outlet 26 positioned in the head portion 22 to dispense skin care treatment material 70 to an outer surface 18 of the head portion 22. The skin care treatment material 70 is one of a lotion, a gel, a cream, and a foam, or some other type of flowable or pumpable material, whether cosmetic or medicinal, or possibly a combination of different types of materials used for skin care. The skin care treatment material 70 is used for treating different types of skin conditions, such as rashes, burns, dry skin, and other such skin conditions.

The head portion 22 includes an applicator pad 28 positioned on the outer surface 18 of the head portion 22, which is designed to rub skin care treatment material 70 into the skin of a user. The outlet 26 of the dispensing assembly 16 is positioned at a central portion of the applicator pad 28. The applicator pad 28 includes a plurality of raised projections 30. The applicator pad 28 may include or be made of rubber or plastic or other similar material, such as silicone.

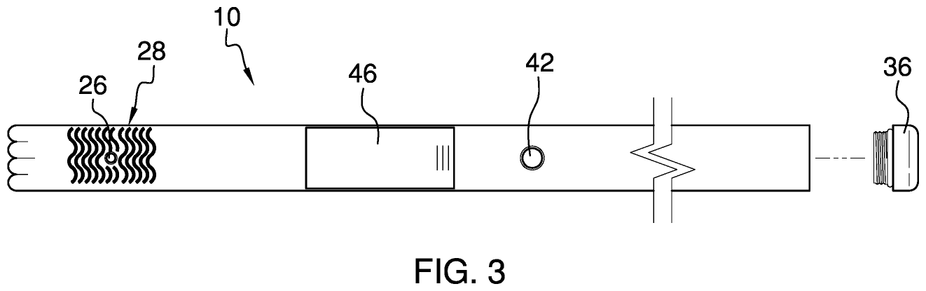

The head portion 22 also includes a projection 32 for scratching the skin of a user, such as on the user's back. The projection 32 includes a plurality of ridges or fingers 34. The projection 32 projects essentially radially from the housing 12 and away from the applicator pad 28, as seen in FIG. 4. The compartment 14 includes a cover, which is an end cap 36 in the exemplary embodiment shown in FIG. 3, detachably mounted in an orifice 38 in the end of the handle portion 20 to permit refilling of the compartment 14, though the cover could be located on the side of the handle portion 20. The end cap 36 and the orifice 38 are threaded to permit a user to screw and unscrew the end cap 36, though the end cap 36 could be detachably connected in other ways, such as a snap fit or a friction fit.

As best seen in FIG. 4, the dispensing assembly 16 includes a power unit 40 operatively connected to the pump 24 and a switch 42 to selectively turn the pump 24 on and off. The power unit 40 includes batteries 44 and a removable cover 46 in the housing 12 to permit replacement of the batteries 44. Alternatively, the removable cover 46 could be omitted and replaced with a charging port, such as a USB charging port, to permit recharging of rechargeable batteries 44 stored in the handle portion 20.

FIG. 5 shows the skin care treatment material applicator 10 in use, wherein a user is applying skin care treatment material 70, in this case lotion for dry skin, to the user's back. The elongated handle portion 20 allows the user to apply the lotion to parts of the body that are difficult to reach. In order to dispense the lotion, the user pushes the switch 42 and turns on the pump 24, which then pumps lotion out of the compartment 14 and to the outlet 26. The lotion exits onto the applicator pad 28 to be rubbed into the user's skin. If desired, the user can flip the head portion 22 over and use the projection 32 as a back scratcher.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A skin care treatment material applicator comprising:
a housing having an outer surface and comprising an elongated handle portion and a head portion to apply skin care treatment material to a user;
a compartment disposed in said housing and containing a supply of flowable skin care treatment material; and
a dispensing assembly disposed in said housing and comprising a pump connected to said compartment and an outlet disposed in said head portion to dispense skin care treatment material to an outer surface of said head portion.

2. The skin care treatment material applicator of claim 1, wherein said head portion comprises an applicator pad disposed on said outer surface of said head portion and configured to rub skin care treatment material into the skin of a user.

3. The skin care treatment material applicator of claim 2, wherein said dispensing assembly comprises a power unit operatively connected to said pump and a switch to selectively turn said pump on and off.

4. The skin care treatment material applicator of claim 3, wherein said head portion comprises a projection for scratching the skin of a user.

5. The skin care treatment material applicator of claim 4, wherein said outlet of said dispensing assembly is disposed at a central portion of said applicator pad.

6. The skin care treatment material applicator of claim 4, wherein said projection comprises a plurality of ridges or fingers.

7. The skin care treatment material applicator of claim 4, wherein said projection projects essentially radially from said housing and away from said applicator pad.

8. The skin care treatment material applicator of claim 4, wherein said applicator pad comprises a plurality of raised projections.

9. The skin care treatment material applicator of claim 4, wherein said applicator pad comprises rubber or plastic.

10. The skin care treatment material applicator of claim 9, wherein said applicator pad comprises silicone.

11. The skin care treatment material applicator of claim 4, wherein said compartment comprises a cover detachably mounted in an orifice in said handle portion to permit refilling of said compartment.

12. The skin care treatment material applicator of claim 11, wherein said cover comprises an end cap and said orifice is disposed in an end of said handle.

13. The skin care treatment material applicator of claim 12, wherein said end cap and said orifice are threaded to permit a user to screw and unscrew said end cap.

14. The skin care treatment material applicator of claim 4, wherein said power unit comprises batteries and a removable cover in said housing to permit replacement of said batteries.

15. The skin care treatment material applicator of claim 1, wherein said dispensing assembly comprises a power unit operatively connected to said pump and a switch to selectively turn said pump on and off.

16. The skin care treatment material applicator of claim 1, wherein said head portion comprises a projection for scratching the skin of a user.

17. The skin care treatment material applicator of claim 1, wherein said outlet of said dispensing assembly is disposed at a central portion of said applicator pad.

18. The skin care treatment material applicator of claim 1, wherein said applicator pad comprises silicone.

19. The skin care treatment material applicator of claim 1, wherein said skin care treatment material comprises one of lotion, gel, cream, and foam.

20. A skin care treatment material applicator comprising:
a housing having an outer surface and comprising an elongated handle portion and a head portion to apply skin care treatment material to a user, wherein:
said head portion comprises an applicator pad disposed on said outer surface of said head portion and configured to rub skin care treatment material into the skin of a user, said outlet of said dispensing assembly is disposed at a central portion of said applicator pad, said applicator pad comprises a plurality of raised projections, said applicator pad comprises rubber or plastic, said applicator pad comprises silicone,
said head portion comprises a projection for scratching the skin of a user, said projection comprises a plurality of ridges or fingers, said projection projects essentially radially from said housing and away from said applicator pad;
a compartment disposed in said housing and containing a supply of flowable skin care treatment material, wherein:
said compartment comprises a cover detachably mounted in an orifice in said handle portion to permit refilling of said compartment, said cover comprises an end cap and said orifice is disposed in an end of said handle, said end cap and said orifice are threaded to permit a user to screw and unscrew said end cap, said skin care treatment material comprises one of lotion, gel, cream, and foam; and
a dispensing assembly disposed in said housing and comprising a pump connected to said compartment and an outlet disposed in said head portion to dispense skin care treatment material to an outer surface of said head portion, wherein:
said dispensing assembly comprises a power unit operatively connected to said pump and a switch to selectively turn said pump on and off, said power unit comprises batteries and a removable cover in said housing to permit replacement of said batteries.
